(19) United States
(12) Patent Application Publication
(10) Pub. No.: US 2025/0137780 A1
(43) Pub. Date: May 1, 2025

(54) The Multiple new angles verification measuring apparatus

(71) Applicant: Jonathan Duane Robinson, Hanover Park, IL (US)

(72) Inventor: Jonathan Duane Robinson, Hanover Park, IL (US)

(21) Appl. No.: 19/002,954

(22) Filed: Dec. 27, 2024

(51) Int. Cl. G01C 9/12; G01C 9/06

(52) U.S. Cl. CPC G01C 9/12; G01C 9/06

(57) ABSTRACT

This new tool cost about the same as its predecessor, but it does what its predecessor does and four other things. It verifies commonly needed angles, slopes, and pitches found in construction situations. It replaces the old bubble between two lines of the spirit level with a more advanced type of pendulum apparatus that relies on gravity. A pendulum usually only points in one direction (downward). This one points in multiple directions. It is exceptionally useful for city code inspectors. It works in the same old generic housing of a regular level. It does what the old spirit level does. It also verifies three of the most common roof pitches. It shows whether your stairs are in the safety range for steepness according to OSHA standards. It verifies whether your plumbing drainage is at the correct slope. It can also measure the actual degrees. It is also expandable.

### BACKGROUND—PRIOR ART

The following is a tabulation of some prior art that presently appears relevant:

U.S. Patents

| Patent Number | Kind Code | Issue Date | Patentee |
|---|---|---|---|
| U.S. Pat. No. 9,964,407 | N/A | 2018 May 8 | Captarencu |
| U.S. Pat. No. 5,163,229 | A | 1992 Nov. 17 | Cantone |
| US2008/0155844 | A1 | 2008 Jul. 3 | Norvell |
| U.S. Pat. No. 7,3925,93 | B2 | 2008 Jul. 1 | AT&T |
| U.S. Pat. No. 7,513,055 | B2 | 2009 Apr. 7 | Montgomery |
| US20070246116 | A1 | 2007 Oct. 25 | Peak, Brans, |
| | | | Hopkins, |

My invention is in the field of technology of tools. It is one of the many types of hand tools. At first sight, it would be mistaken for a level because my invention could also be housed in an elongated rectangular prism-shaped body, similar to the common spirit level. The outward appearance would be very much like the U.S. Pat. No. 9,964,407 B2 to Captarencu et al. 2018. However, my Multiple New Angles Verification Measuring Apparatus (MNAVMA) increases the functionality of the old spirit level by 400%. The spirit level, known as the bubble level, was invented about 360 years ago by a French scientist named Melchisedech Thevenot. I hope that it lends to the unobviousness of my invention that no one has been able to make a 400% increase in its functionality in over 300 years. Replacing the not as accurate (bubble between two lines) level with focused pointed indicators might be a welcomed change.

More broadly, the present type of level might be seen in the future as sort of a one-trick pony. You could check your pool table to make sure that the balls don't roll on their own or make sure your floor is even. Another feature of the old spirit level is that there are usually one or more openings in the elongated rectangular prism housing where the liquid vials (bubble mechanisms) are placed. There was one other bubble-type improvement over the old bubble-type vial. U.S. Pat. No. 7,513,055 B2 to Montgomery in 2009 still used the bubble, it could actually measure a few more degrees. But it was still a bubble level. It turned the bubble level into more of a measuring device. I consider the original bubble level a verification instrument. It verified three distinct angles. What most people call level, some would call a 0-degree angle. The bubble level also verified two other angles. It verified the 90-degree angle, which is vertical or plumb, and it verified the 45-degree angle. Montgomery's invention measured a range of degrees more than it verified specific angles. But it was indeed a spirit level on steroids. But they all lack the precision of my invention and the power of verifying numerous more specific commonly needed angles.

In my search to find an instrument that measured plumb, I only found one that might be able to be miniaturized and fit inside the housing of a common-level type device. The U.S. Pat. No. 5,163,229 to Cantone in 1992 could conceivably do a good job of pointing precisely at an angle straight down. It also, like mine, used a pendulum pointing device, which means that gravity was its principal means of motivation Instead of the floating of the liquid vial bubble between two lines. The most serious drawback of this device Is that it did nothing else. It was the real one-trick pony. Even the regular spirit level had a functional increase in usefulness compared to Cantone's. Building Cantone's invention into the housing of a regular elongated rectangular prism-type level instrument would probably require a spherical-shaped see-through window to view the measuring device.

I also found other measuring-type devices that could be built into a level-type housing with incremented graduating scales. The U.S. Pat. No. 7,392,593 B2 to Rivers and Diggle 2008 had graduated scales with a pendulum-type pointing device and two built-in liquid spirit levels. The built-in spirit levels could help to verify the accuracy of the pendulum pointing device. This made it a combination of a verification tool and a measuring tool. The major difference between this one and mine is that mine verifies a specific group of angles that have been predetermined to be useful if you are a carpenter, a contractor, or a code inspector. The one patented by Rivers and Diggle Only seems to verify its own measurements. Mine also verifies its own measurements along with verifying some commonly needed measurements without having to look up the actual angles. One of the background features of my invention is a regular angle-measuring device. But I don't believe that measuring for specific angles is needed as much as verifying some commonly occurring angles in the process of building or rehabbing or checking carpentry and other building works.

There is one other invention that could almost be the sister or brother to the before mentioned tool. The U.S. patent 2008/0155844 A1 to Norvell, 2008. This is also the one that most closely resembles the construction of my invention. There are some striking similarities, in principle, between the physical construction of the mine and Norvell's, except for the fact that his is also strictly a degree measuring tool or a tool to discover the specific angle of a surface. What I mean when I say that it is only a measuring device is this. When someone uses The Multiple New Angles Verification Measuring Apparatus (my invention), a supposed angle is already known. You are not trying to make the angle; you are checking to make sure that the angle is true. With mine, the graduated scale is built into my indicators, and like the bubble level, a graduated scale is not needed to verify surfaces or angle's correctness. As you will see later, the graduated scale or bubble will not help you do some of what mine is built to do. I believe that mine is a true replacement for the old spirit level because mine also uses symbolic measures instead of numbers, just as the bubble between two lines does. The person using my tool will look for the alignment of two points instead of the actual degrees. Also, as you will see later, mine is also sometimes a visual representation of a range of angles or an angle specific to a certain job.

The next nearest thing I could find in my searches for relevant material was one invention being used to measure the drainage slope of a pipe. One of the functions of my invention is that it can readily identify whether the slope of a drain pipe is appropriate without looking for an angle or having to calculate the angle using the length of the pipe and the distance of the rise or fall of the pipe. While doing my search for something similar I found a tool called a plumber's level. I went to search the patents and couldn't find a plumber's level at all. However, the plumber's level is almost identical to the regular liquid vial level. Instead of a bubble between two lines, there was a liquid vial with four lines, each line represented a slope somewhere between ⅛ of an inch per one-foot drop to find the slope, and up to one-half of an inch per one foot drop of a distance to measure the slope. It may have been considered to be too much of a natural progression from the regular liquid vial (spirit) level to attain a patent. However, the nearest patent that I found that was created to measure the slope of a pipe was the U.S. patent 2007/0246116 A1 to Peak, Branscomb, Hopkins, and Bowden, 2007. But unlike the other levels and my own, this device would not seem likely to fit inside a hole or holes in the side of an elongated rectangular prism-type housing. It was a combination of two small spirit-level liquid vials attached to a flat platform that could be seated on top of the pipe and was meant to be viewed from above. But, like the original spirit level, that would be its one and only function.

### Advantages

My invention gets rid of the bubble liquid vial mechanism with the bubble between two lines and replaces it with a new multi directional type of pendulum device(s). This means mine points in more directions than down and measures in a different way. It is more accurate because you have to align two arrowheads or pointers towards each other. The arrowhead/pointer may also be pointed toward a range of predetermined degrees. You can know the pitch of a roof by laying my invention flat on the roof, and one of the arrowheads will point to a line indicating whether the roof has a 4/12 pitch, a 6/12 pitch, or a 8/12 pitch (that's one advantage). If you lay this new device on a pipe, a pointer or arrowhead will point between a range between a ¼ inch per foot slope and a ½ inch per foot slope, indicating that the slope would be correct for proper drainage (that's two advantages). If you lay the device on some residential stairs, the arrowhead or pointer would land between a predetermined range of degree symbols that indicate whether the stairwell steepness is within the OSHA federal standard guidelines for safety (that's three). That would be a 300% increase in functionality from the old spirit level. But it can also show you whether a surface is plumb (0 degrees), Vertical (90 degrees), or diagonal (45 degrees), like the old spirit level. It is also capable of giving you graduated scale measurements of any degree between zero degrees and 180 degrees (that makes it 400%). If installed in more than one of the openings in the elongated rectangular prism shaped housing, It can be used to verify not only the before mentioned slopes and pitches but also each other. What I'm saying here is that if more than one of them agrees with each other, you can be more certain of its accuracy. It can also be designed to be capable of verifying any predetermined angles. There would be no math necessary to verify some slopes and angles. For all practical purposes, they (common angles that need to be identified quickly) would be immediately identifiable in the same manner as the regular old spirit level. Recognizes plumb, vertical, and diagonal.

### DRAWINGS—FIGURES

In the drawings, closely related figures have the same numbers but different alphabetic suffixes.

FIG. 1 shows a typical housing for a generic leveling tool. I will sometimes refer to it as an elongated rectangular prism. It will have one or more openings to hold the device(s) that do the verifying or measuring.

FIG. 2 shows all 5 of the parts that are permanently affixed to the housing and placed inside one or more of the openings of the housing.

FIG. 3 on figure page ¾ shows two different types of decals. The two on the left show the outer ring decals as they surround the pendulum decal. The one on the right shows the pendulum ring decal by itself. If you look closely, you can see that the pendulum ring decal on the right is smaller. The left side shows how the outer ring decals are superimposed over and around the pendulum ring decal.

FIG. 4 shows two types of precalculated angle or measuring device(s). The ones on the left (the complete outer ring decals) are named outer ring decals on this invention. The ones on the right show them combined with the outer ring decal in order to make a verification or measurement.

Drawings - Reference Numerals

| | |
|---|---|
| 10 housing | 12 holsters |
| 14 overlay slots | 16 openings |
| 18 pendulum ring decal | 20 outer lens cap |
| 22 inner lens cap | 24 spacers |
| 26 bearing | 28 multi-directional pointing disc |
| 30 weight | 32 outer ring decal |
| 34 outer axel hub | 36 inner axel hub |
| 38 inner bearing ring | 40 outer bearing ring |
| 42 ball bearings | 44 inside view of the multi-directional pointing |

### DETAILED DESCRIPTION—FIRST EMBODIMENT

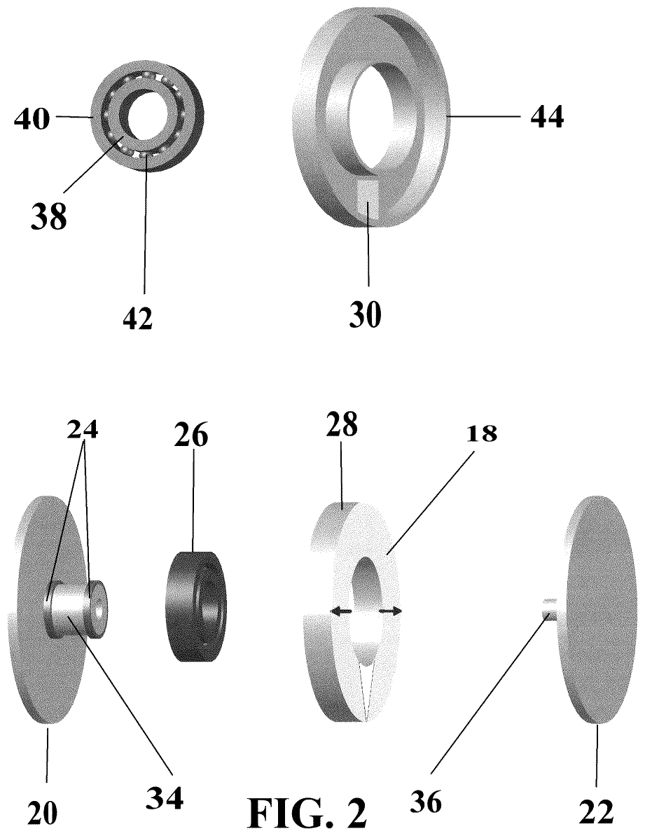

There are only eight parts to this device. For a precursor to this section you should know that the drawing reference numbers are even numbers starting with number 10 and ending with number 44. Now, let me disclose something that I hope will put your mind at ease. Half of these reference numbers belong to very generic parts that will be exactly what they sound like, or they will be the inner or outer type of a part, or easy to remember pieces inside an already familiar part. It has two transparent interlocking lens caps 20 & 22 (FIG. 2). You will find them on the far left and right of the bottom half of FIG. 2. They are flat transparent circular plates with interlocking axel hubs 34 & 36, which are part of the before mentioned lens caps 20 & 22. The outer axel hub 34 is a hollow pipe like cylinder while the inner axel hub 36 enters it to fit together with the other pieces in between the lens caps 20 & 22. They make a male/female type connection. The parts in the bottom half of FIG. 2 are an exploded view (in general) of this new device and the parts in the top half of FIG. 2 are closer looks at a couple of the parts in the bottom half of that page.

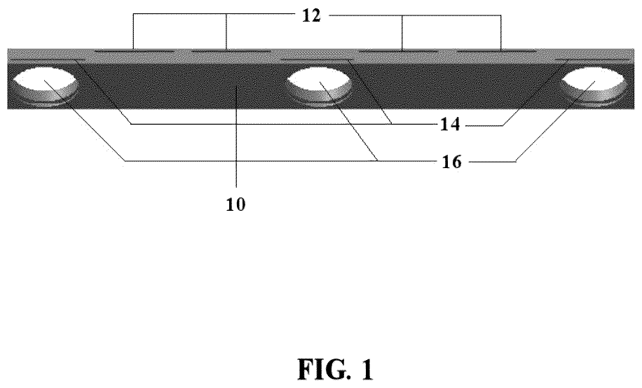

Looking at the upper half of FIG. 2, the part on the left shows the pieces of the bearing 26 that is on the bottom half of the (FIG. 2) page. The bearing has three sections in all. It has an outer bearing ring 40. Closest to the center, it has the inner bearing ring 38 and some ball bearings 42 sandwiched between the outer bearing ring 40 and the inner bearing ring 38. The bearing 26 itself fits between the two spacers 24, which you can see in their proper positions around the outer axel hub 34. The multi-directional pointing disc 28 goes around the bearing 26 and the both of them fit between the transparent outer lens cap 20 and the transparent inner lens cap 22. The outer edges of the lens caps are attached (probably glued) to the housing 10 (FIG. 1). You can see where the parts can fit between the openings 16 in the housing 10 (FIG. 1) at the open edges. The parts would fit inside the housing 10 (FIG. 1) where the liquid vial fits inside the old bubble levels (that measured a level surface with a bubble between two lines). This invention replaces the old bubble (spirit) level and adds four more angle verification task.

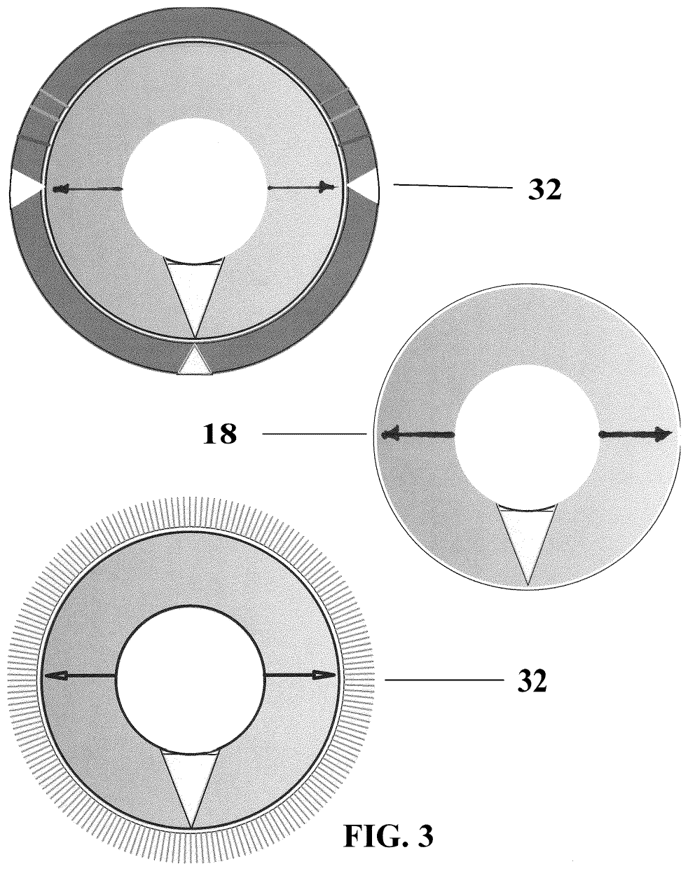

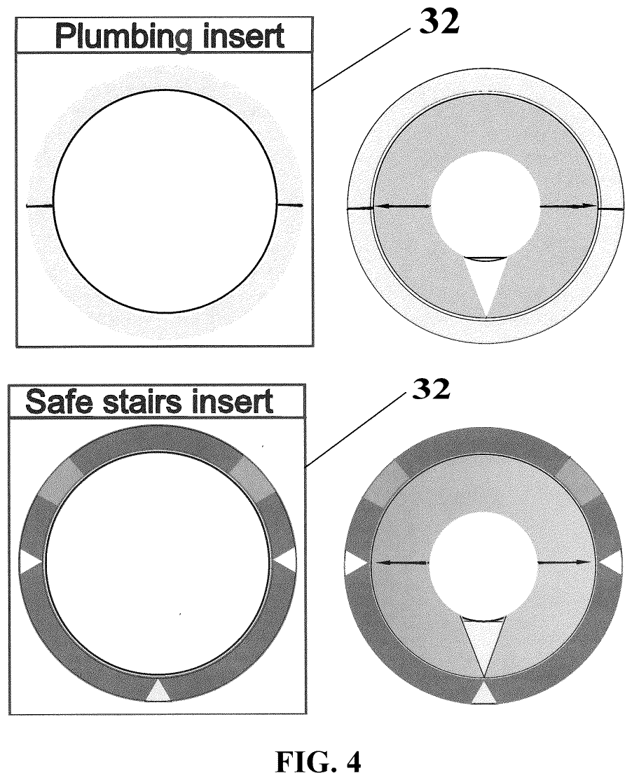

Besides the housing 10, only one other part is not inside and between the transparent inner lens cap 22 window and the outer lens cap 20 window and that other part is the outer ring decal 32 (FIG. 4). But before we go on to the outer ring decals 32 (FIG. 4), let's go back to FIG. 2 and finish explaining the parts inside the lens caps 20 & 22. When you are holding the tool in your hand and you are looking into one of the windows of one of the lens caps 20 & 22, one of the things you will see is the pendulum ring decal 18 (FIG. 2 & FIG. 3) because the pendulum ring decal 18 is always on the side of the multi-directional pointing disc 28 facing the lens caps 20 & 22. There is more that needs to be explained about the multi-directional pointing disc 28. In FIG. 2, if you look directly above the multi-directional pointing disc 28, you will see the inside view of the multi-directional pointing disc 44. You can see that it is hollow inside and you can also see that there is a weight 30 secured inside at the bottom. This weight 30 is behind the downward pointing indicator on the pendulum ring decal 18, which is on the outside of the multi-directional pointing disc 28. Please visualize the multi-directional pointing disc 28 fitting on the outside around the outer bearing ring 40. The multi-directional pointing disc 28 can revolve around the inside parts of the bearing 26. But the weight 30 inside the multi-directional pointing disc 28 assures that the downward pointing indicator on the pendulum ring decal 18 is always pointing downward. So, no matter at what angle you hold the housing 10 (FIG. 1), the triangular downward pointing indicator on the pendulum ring decal 18 will be pointing downward. Not only that, but the two side arrows on the pendulum ring decal 18 will always indicate level or 0 degrees. The thing to remember about any bearing is that the outside can revolve around the inside of the bearing like a wheel around its hub.

Not many parts left now. Please go to FIG. 4. We will use the bottom half of the page. The left side of the bottom half of the page shows an entire outer ring decal 32. The outer ring decals 32 are stored in their holsters 12 (FIG. 1) on the top of the housing 10 FIG. 1. The (example) holsters 12 in FIG. 1 shows four of them. One for verifying the most common roof-top pitches, one for checking for the proper drainage slope of a drainpipe, one for making sure a set of stairs are not too steep according to OSHA standards, and one for measuring degrees of inclined surfaces. The housing 10 also has three overlay slots 14. These overlay slots 14 are where the outer ring decals 32 are inserted while covering the opening areas to make a verification.

### Operation—

I envision this tool to be best suited for use by a code inspector. I purchased a web site for this invention in case it becomes a reality. It's not active yet but, codeinspectorslevel.com might be showing customers how to use the new device. Operating this tool goes like this. Let's say you are a code inspector, and someone has put in a new stairway without your knowledge and someone else has fallen down the stairs and they are saying that it was because the stairs are too steep. This is what the code inspector will have to do. He takes the outer ring decals 32 (for checking stairs) out of their appropriate holster 12 and inserts them into overlay slots 14. He could use just one if he likes, but when using all three, they (each outer ring decal 32) can also verify each other's measurements for more accuracy. Then, if he is holding the device level he will see something like the lower right side illustration in FIG. 4 when he looks at the device(s) in the opening(s) 16 areas. He will see the outer ring decal 32 superimposed over and around the pendulum ring decal 18. Once the inspector lays the instrument down on the stairs, the outer ring decal 32 will tilt with the housing 10, but the pendulum ring decal 18 will still be pointing down. When one of the side arrows on the pendulum ring decal falls within one of the two upper lighter shaded areas on the outer ring decal, it will indicate that the stairs are built at a safe angle according to OSHA guidelines. The reason for the two lighter shaded areas is so the verification can be done whether the stairs incline up to the left or up to the right.

### First Alternative Embodiment

In this alternative embodiment, there are no interchangeable outer ring decals 32. There are no outer ring decals 32 parts at all. All the angle measuring symbols that you want to verify are installed permanently at the opening 16 sights. There is no need for holsters 12 or overlay slots 14. You can verify all four of the things the original embodiment does with what is permanently installed in the housing 10 openings 16. The problem is that the measuring window is normally only about 2 inches in diameter, and putting all of the information for all four decals inside that tiny viewing area would make it very cluttered and confusing. You would probably have to increase the size of the housing 10 (FIG. 1) and increase the size of the Multiple New Angles Verification Measuring Apparatus. Of course, this could increase the tool's price until the price would make it harder to sell. If all four functions could be permanently placed around one pendulum ring decal without the need to handle external pieces at a reasonable price, this would be the next logical advancement of this tool.

### Second Alternative Embodiment

In this embodiment, there are two major changes. The first change would be in the housing 10. It would have to be different. Please imagine the openings 16 at the ends of the housing would have to be brought in closer to the middle of the housing 10. The openings 16 in the housing 10 would also be spaced the same distances away from each other. Let's say that each opening is eight inches apart and that there are still three openings. Now visualize that the front of the housing 10 is four inches high, about 3 feet long, and it is about one inch thick. Flush against the side of the housing 10 and permanently affixed to it is something resembling a transparent sheet of glass or a acrylic sheet that is also four inches wide and slides back and forth along the length of the housing 10. This sheet covers all three openings 16 and all the rest of the Multiple New Angles Verification Measuring Apparatus parts that are inside. The images of the four different outer ring decals 32 are on this transparent sliding sheet that is attached to the housing 10. They are also spaced eight inches apart so that when you slide the sheet back and forth along the housing 10, the four sets of outer ring decals, will be superimposed over and around the matching pendulum ring decals 18. This will have the same effect as placing the outer ring decals 32 inside the overlay slots 14, because all 4 of the outer ring decals 32 would be put on the sliding mechanism and you would simply have to slide the appropriate outer ring decals 32 over to the pendulum ring decals in the housings before making the verification.

There is one other significant change that could be made to all embodiments of the Multiple New Angles Verification Measuring Apparatus. The multi-directional pointing disc 28 could be made in a radically different way while yielding the same effect. You could remove the bearing 26 and the multi-directional pointing disc 28 and change the outer and inner axel hubs 34 & 36 into a very small diameter cylinder that goes from the center of one of the lens caps 20 & 22 to the other. The following would replace the multi-directional pointing disc 28 (FIG. 2) and the pendulum ring decals 18. Visualize a needle hanging down from the new small diameter cylinder that bridges between the two lens caps 20 & 22. The needle hangs down from the new small diameter cylinder that bridges between the two lens caps 20 & 22 (that has replaced the outer axel hub 34 and the inner axel hub 36) by its eye. So, this needle would be hanging by its eye from the new small diameter cylinder that bridges between the two lens caps 20 & 22. The needle would be the new downward-pointing device. But there would be one more modification to the needle to make it multi-directional. Now visualize a bar that looks the same as the shaft of the needle going across the top of the needle through the eye (but not blocking it), making it look like a capital T. This bar would be the other two pointers. So, there would be three pointers, all the same length, coming from the eye of the needle. They would all be the same length, except that the downward pointing needle would be much heavier than the other two because it would be the new weight. This and gravity would keep it pointing downward. There would have to be some modified spacers to keep it from rubbing against the inside of the lens caps 20 & 22. But this could work much like the original multi-directional pointing disc.

### Advantages—

There are five advantages to the Multiple New Angles Verification Measuring Apparatus. The spirit level gives a close verification of how horizontal, vertical, or diagonal a surface or object is. The bubble between two lines has a particular usefulness. But my multiple new angles verification apparatus gives a more precise readout. It gives a pointer-to-pointer readout that aligns the tips of pointers to measure and verify angles. However, the spirit level has not changed in any significant way in 300 years. Up until now it has been sort of a one-trick pony. It verifies horizontal, vertical, and diagonal (45 degrees) angles. So, the first advantage is a more precise measurement. Then, the Multiple New Angles Verification Measuring Apparatus also increases the functionality of the old spirit level by 400%, and here's how. For plumbers, this tool verifies the slope angle of a drain pipe. You no longer have to create a level line over the pipe and measure a distance out and a distance down to get a ratio from those numbers to verify the angle or have to purchase separate plumber's bubble level. You just place this new device on the pipe, and it has a predetermined angle line on the appropriate outer ring decal 32 that will align with one of the side arrows on the pendulum ring decal 28 if the slope of the pipe is correct. The third advantage and new function is that it verifies the three most common roof pitches. There are many reasons why a contractor or a code inspector may need to know the pitch of a roof, but as of now, they must get up to the roof, and then they put one end of the level on the roof while they hold the rest of the level out horizontally from the slope of the roof. Then they measure a distance out from where the level touches the roof and measure a distance down to the roof from the elevated end of the level. Then they make a calculation with those numbers that will give them the pitch of the roof. Most of that is unnecessary with this new device. You just lay the Multiple New Angles Verification Measuring Apparatus flat against the roof straight down the slope of the roof and see which of the precalculated roof pitch angle lines on the appropriate outer ring decal 32 match up to one of the side arrow pointers on the pendulum ring decal 18. There could be decals for all standard roof pitches.

There are three additional advantages. There are no more mistakes due to miscalculations. It becomes much easier to train an employee to do that job, and you need fewer tools to accomplish the task.

### CONCLUSION, RAMIFICATION, AND SCOPE

Thus, the reader can see that it has been a long time coming for an upgrade for the old bubble level, and now there is something that adds so much to it that it is no longer just one tool. I'm sure there will be even more angles that will have to be added to this new system of verifying angles. So, there will later have to be more outer ring decals 32 added to the toolset for this device.

Over time, this instrument will be able to streamline specific tasks. It will also be able to streamline the training of employees in doing these particular tasks relevant to this tool. It will eliminate the need to calculate some measurements that were necessary before. It is a tool that will make some jobs quicker and easier.

I claim:

1. An angle measuring and angle verifying device or devices housed in an elongated linear generic type housing typical of most levels comprising:
a. a single or multiple openings in which angle measuring and/or verifying instrument(s) are used and
b. a single or multiple places used to store pre-calculated angle or measurement devices that help determine or verify slopes, pitches, angles, and degrees and
c. a pendulum-type device that can point in multiple directions simultaneously so that it may measure or verify an angle or range of angles, whether it slopes up to the left or whether it slopes up to the right and
d. a single or multiple places where a properly selected pre-calculated angle or measurement device will be partnered with the rest of the device to complete all the parts needed to make the necessary measurement or verification and
e. a device or devices to do a more accurate job than the old spirit level with pointers and to do at least four other jobs of measuring and/or verifying angles, slopes, and pitches and also identify surfaces that are horizontal, vertical, or diagonal and
f. representative symbols and pointers working together to measure or verify slopes, pitches, angles, and degrees and
i. a means by which using the above-mentioned claims to create a digital version that may need electrical components to build.
